(19) United States
(12) Patent Application Publication
(10) Pub. No.: US 2013/0091685 A1
(43) Pub. Date: Apr. 18, 2013

(54) METHOD OF APPLYING PRE-TIGHTENING FORCE ON AN ANCHOR BOLT

(71) Applicant: SINOVEL WIND GROUP CO., LTD, BEIJING (CN)

(72) Inventors: HONGBING ZHU, BEIJING (CN); SHUAIQUAN ZHENG, BEIJING (CN); LlANJIANG SONG, BEIJING (CN)

(73) Assignee: SINOVEL WIND GROUP CO., LTD, BEIJING (CN)

(21) Appl. No.: 13/652,074

(22) Filed: Oct. 15, 2012

(30) Foreign Application Priority Data
Oct. 17, 2011 (CN) 201110313649.5

(51) Int. Cl. B23P 11/02

(52) U.S. Cl. 29/446

(57) ABSTRACT

The present invention provides a method of applying a pre-tightening force on an anchor bolt, which comprises: installing washers with a predetermined dimension between tower flange and fastening nuts, the washers are configured to support the supporting bridge of tensioner; applying a pre-tightening force on the anchor bolts in an inner ring and the anchor bolts in an outer ring installed on the tower flange with the tensioners. According to the present invention, the method of applying a pre-tightening force on an anchor bolt adopts the washer with a predetermined dimension to replace the conventional washer, such that the tensioner will not directly contact the surface of tower flange, and pressure of the tensioner is transmitted uniformly to tower flange via the washer, avoiding damage to paint on the surface of tower flange and improving installation quality and service life of the tower.

### CROSS-REFERENCE TO RELATED APPLICATIONS

This application claims priority to Chinese Patent Application No. 201110313649.5, filed on Oct. 17, 2011, entitled “Method of Applying Pre-tightening Force on an Anchor Bolt”, which is incorporated herein by reference in its entirety.

### FIELD OF THE TECHNOLOGY

The present invention relates to mechanical technology, and particularly to a method of applying a pre-tightening force on an anchor bolt.

### BACKGROUND

The steel tower of wind turbine is generally fixed with embedded fasteners, taking the conventional embedded bolts for example, the tower is fixed as follows: part of an anchor bolt 1 is embedded in concrete 16, the rest protrudes from the concrete 16; one end of the anchor bolt 1 in the concrete 16 is screwed on with a fixing nut 2; the part of the anchor bolt 1 protruding from the concrete 16 penetrates through a shimming flange 3 and a tower flange 4 from bottom to top after penetrating through the concrete 16, then is screwed on with a fixing nut 5, and the specific schematic diagram is as shown in FIG. 1.

To ensure installation reliability of the tower, the axial force subjected to by an anchor bolt should be equal to a predetermined pre-tightening force. Generally, a tensioner is used to pre-tighten the anchor bolts one by one. The anchor bolts installed at the bottom of the tower generally are arranged in an inner ring and an outer ring, taking 96 anchor bolts in each of the rings for example, there are 192 anchor bolts in total. The tensioner comprises a supporting bridge, a telescopic boom and a stretching head. In use, the supporting bridge is disposed on tower flange, and the stretching head and the top of the anchor bolt are fixed. The telescopic boom protrudes against the stretching head and drives the anchor bolt to stretch upwards. After the anchor bolt is stretched, the fastening nut will not be in contact with the surface of tower flange any more, and re-tightening the fastening nut can apply a pre-tightening force on the anchor bolt. The tensioner works powered by an oil pump.

The following problems exist in the prior art, for example, the supporting bridge of tensioner is directly disposed on the tower flange, which is easy to damage paint on the surface of the tower flange and thus influences the quality and service life of the tower.

### SUMMARY

An object of the present invention is to provide a method of applying a pre-tightening force on an anchor bolt, aiming to optimize the conventional method of applying a pre-tightening force on an anchor bolt and improve performance of the tower.

One aspect of the present invention provides a method of applying a pre-tightening force on an anchor bolt, comprising:

installing a washer with a predetermined dimension between a tower flange and a fastening nut, wherein the washer is configured to support a supporting bridge of a tensioner;

applying a pre-tightening force on anchor bolts in an inner ring and an outer ring installed on the tower flange with the tensioner.

The above method of applying a pre-tightening force on an anchor bolt, preferably, before installing the washer with a predetermined dimension between the tower flange and the fastening nut for supporting the supporting bridge of the tensioner, further comprising:

numbering the anchor bolts in each of the rings, and recording a serial number of each anchor bolt, wherein, the anchor bolts in each of the rings are equally divided into at least two groups, the number of the anchor bolts in each group is N, and N is a natural number.

In the above method of applying a pre-tightening force on an anchor bolt, preferably, the step of applying a pre-tightening force on anchor bolts in an inner ring and an outer ring installed on the tower flange comprises:

according to the serial number, applying a pre-tightening force on the i-th anchor bolt in each group simultaneously until all the anchor bolts in each group have been applied with a pre-tightening force equal to about half of a predetermined value, wherein, 1≦i≦N;

according to the serial number, applying a pre-tightening force on the i-th anchor bolt in each group simultaneously until all the anchor bolts in each group have been applied with a pre-tightening force equal to the predetermined value, wherein, 1≦i≦N.

In the above method of applying a pre-tightening force on an anchor bolt, preferably, the step of numbering the anchor bolts in each of the rings comprises:

numbering the anchor bolt positioned right facing the tower door of the tower in each of the rings as “1”, and numbering successively all the anchor bolts in each of the rings in the clockwise direction.

In the above method of applying a pre-tightening force on an anchor bolt, preferably:

the number of the tensioners equals to the product of the number of groups of the anchor bolts in each of the rings and the number of the rings, and the tensioners used in each of the rings are connected in series.

In the above method of applying a pre-tightening force on an anchor bolt, preferably, the step of recording the serial number of each anchor bolt comprises:

marking the serial number on the anchor bolt with pigment.

In the above method of applying a pre-tightening force on an anchor bolt, preferably:

a length of the anchor bolt clamped by a stretching head of the tensioner is no less than 1.5 times of the diameter of the anchor bolt.

In the above method of applying a pre-tightening force on an anchor bolt, preferably:

the predetermined dimension of the washer is the radial dimension of the washer, which is greater than the radial dimension of the supporting bridge of the tensioner.

According to various aspects of the present invention, the method of applying a pre-tightening force on an anchor bolt adopts a washer with a predetermined dimension to replace the conventional washer, such that the tensioner will not directly contact the surface of the tower flange, and the pressure of the tensioner is transmitted uniformly to the tower flange via the washer, avoiding damage to paint on the surface of the tower flange and improving installation quality and service life of the tower.

### BRIEF DESCRIPTION OF THE DRAWINGS

FIG. 1 is a partial installation schematic diagram of the tower in the prior art;

FIG. 2a is a flow schematic diagram of the method of applying a pre-tightening force on an anchor bolt according to Embodiment 1 of the present invention;

FIG. 2b is an installation schematic diagram of the tensioner according to Embodiment 1 of the present invention;

FIG. 3a is a flow schematic diagram of the method of applying a pre-tightening force on an anchor bolt according to Embodiment 2 of the present invention;

FIG. 3b is a schematic diagram of numbering the anchor bolts according to Embodiment 2 of the present invention;

FIG. 3c is a schematic diagram of the tensioners in series according to Embodiment 2 of the present invention.

| | | |
|---|---|---|
| 1-anchor bolt | 2-fixing nut | 3, 11-shimming flange |
| 4, 9-tower flange | 5-fastening nut | 6-tensioner |
| 61-supporting bridge | 7-washer | 62-stretching head |
| 8-anchor bolt | 63-telescopic boom | 64-oil cylinder |
| 65-shifting ring | 65-through-hole | 10-tower wall |
| 12-oil pipe | 13-oil pump | 16-concrete |

### DETAILED DESCRIPTION

In order to make the purposes, technical solution and advantages of the embodiments of the present invention clearer, the technical solution in the embodiments of the present invention will be clearly and completely described hereinafter with reference to the drawings. Obviously, those described here are not all but only a part of embodiments of the present invention. On the basis of the described embodiments of the present invention, all other embodiments obtained by those skilled in the art without any creative work should fall in the protection scope of the present invention.

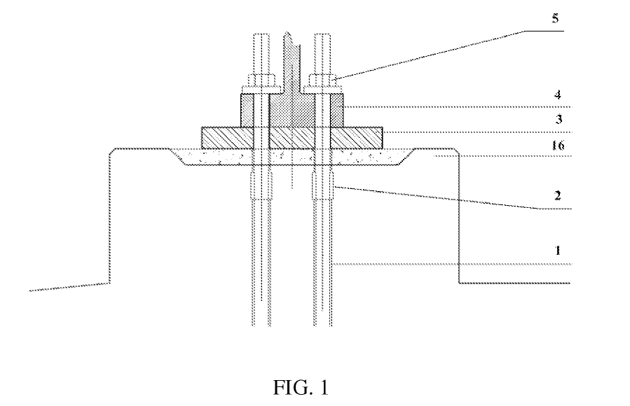

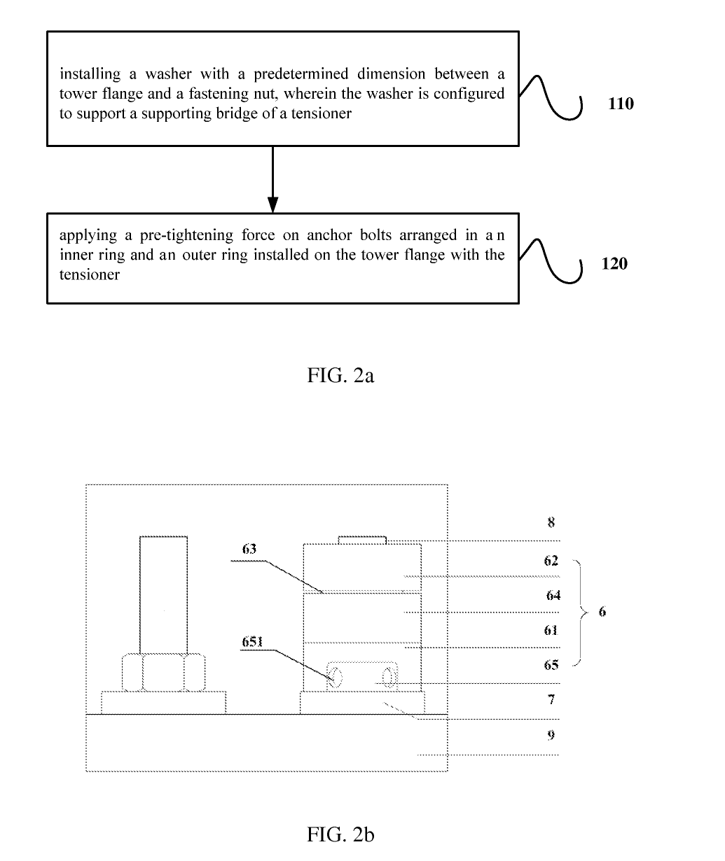

Embodiment 1 of the present invention provides a method of applying a pre-tightening force on an anchor bolt, the method is typically suitable for pre-tightening anchor bolts on wind turbine generator system (WTGS) as shown in FIG. 1, the flow schematic diagram of the method is shown in FIG. 2a, and the installation schematic diagram of the tensioner is shown in FIG. 2b. The method comprises the following steps:

Step 110, installing a washer 7 with a predetermined dimension between a tower flange 9 and a fastening nut, wherein the washer 7 is configured to support a supporting bridge 61 of a tensioner 6.

The dimension of the washer 7 can be greater than, less than or equal to the dimension of the supporting bridge 61 of the tensioner 6, however, in order to reduce the pressure subjected to by the washer 7, preferably, the predetermined dimension of the washer 7 is the radial dimension of the washer 7, which is greater than the radial dimension of the supporting bridge 61 of the tensioner 6. The radial dimension of the washer is greater than the radial dimension of the supporting bridge of the tensioner, such that the supporting bridge of the tensioner can be disposed on the washer in a convenient way. Furthermore, the washer should be as thick as possible, here, the thickness can be 15 mm-30 mm Optionally, selecting washer with greater width and thickness can also make the supporting surface of the tensioner's supporting bridge fully supported on the washer, the washer can transmit uniformly pressure of the tensioner to the tower flange, thus avoiding damage to paint on the surface of the tower flange and improving installation quality and service life of the tower. Here, a conventional tensioner can be used.

Here, the axial force subjected to by the washer 7 is relatively great and, therefore, the washer 7 should be made of metal.

Step 120, applying a pre-tightening force on anchor bolts 8 arranged in an inner ring and in an outer ring installed on the tower flange 9 with the tensioners 6.

Preferably, the length of the anchor bolt 8 clamped by stretching head 62 of the tensioner 6 is no less than 1.5 times of the diameter of the anchor bolt 8. In this way, the connection between the stretching head 62 and anchor bolt 8 is more reliable.

The installation schematic diagram of the tensioner is as shown in FIG. 2b, when the tensioner 6 is used, the supporting bridge 61 of the tensioner 6 is disposed on the washer 7, the tower flange 9 is under the washer 7, the stretching head 62 of the tensioner 6 is fixed to the top portion of the anchor bolt 8, a shifting ring 65 of the tensioner 6 surrounds the outside of a fastening nut (not shown), a telescopic boom 63 of the tensioner 6 protrudes when driven by an oil cylinder 64, not only stretching the anchor bolt 8, but also applying a pre-tightening force on the anchor bolt 8. There are six through-holes 651 in the shifting ring 65, and the fastening nut can be rotated via the through-holes 651. The advantages of using the tensioner are that: the force applied by the tensioner 6 on the anchor bolt 8 is mainly axial force, since there is no torque, the anchor bolt 8 will not rotate due to torque, thereby avoiding damage to the concrete layer and influence on installation safety of the tower.

According to Embodiment 1 of the present invention, the method of applying a pre-tightening force on an anchor bolt adopts a washer with a predetermined dimension to replace the conventional washer, such that the tensioner will not directly contact the surface of the tower flange, avoiding damage to paint on the surface of the tower flange and improving installation quality and service life of the tower.

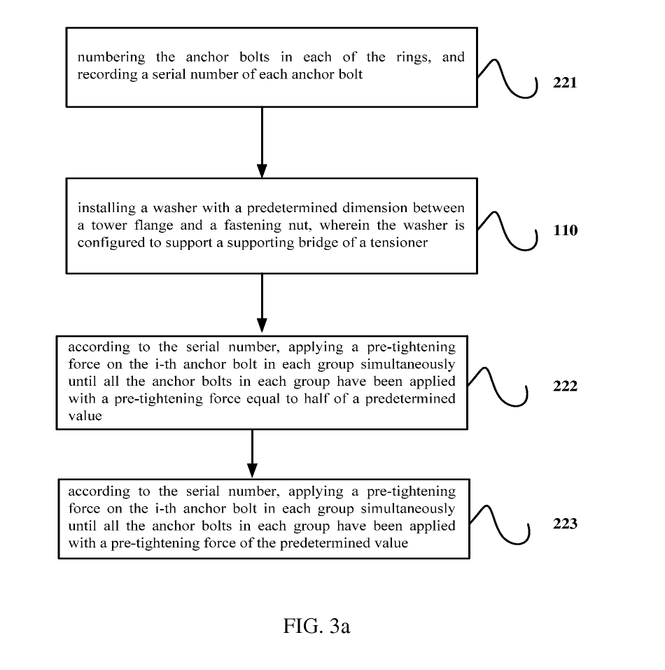

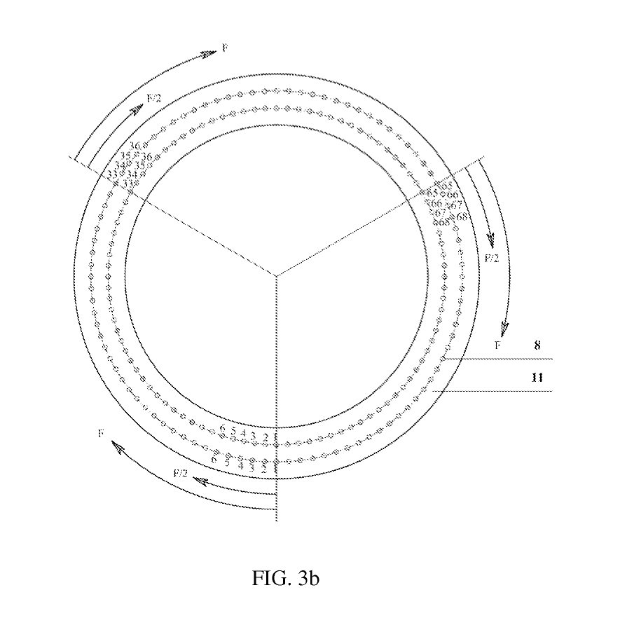

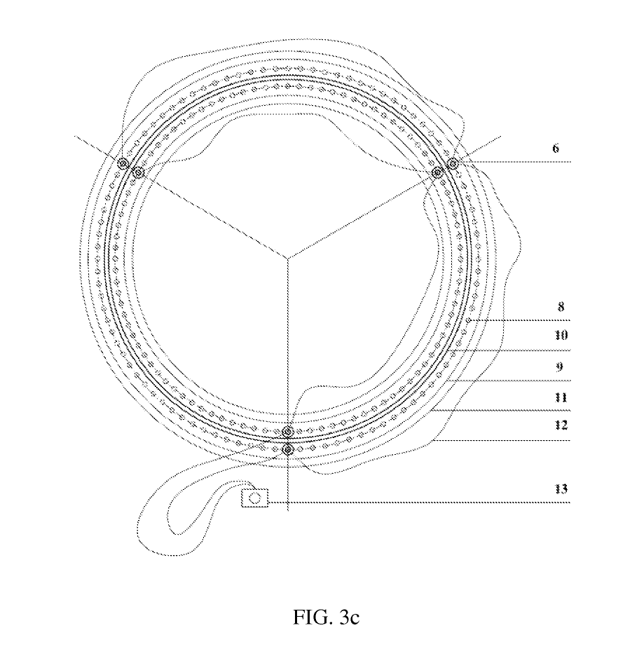

FIG. 3a is a flow schematic diagram of the method of applying a pre-tightening force on an anchor bolt according to Embodiment 2 of the present invention. On the basis of the technical solutions of Embodiment 1, Embodiment 2 of the present invention, preferably, prior to Step 110, further comprises the following steps:

Step 221, numbering anchor bolts 8 in each of the rings, and recording a serial number of each anchor bolt 8, wherein, the anchor bolts 8 in each of the rings are equally divided into at least two groups, the number of the anchor bolts 8 in each group is N, and N is a natural number.

The schematic diagram of the numbered anchor bolts is as shown in FIG. 3b. Firstly, anchor bolts are numbered before the tower is hoisted, and particularly, the numbering manner is as follows: numbering the anchor bolt right facing the tower door of the tower in each of the rings as “1”, and numbering successively all the anchor bolts in each of the rings in the clockwise direction. Embodiments of the present invention take two rings of anchor bolts and 96 anchor bolts in each of the rings as an example. Numbering anchor bolts facilitates to record the working process, thus improving working efficiency and avoiding missing some anchor bolts or repeating operations on some anchor bolts.

In practical application, optionally, marking the serial number on the anchor bolt with pigment, and the pigment should be those with strong adhesive force, not easy to fade and waterproof.

Embodiments of the present invention take three groups of anchor bolts in each of the rings and N=32 anchor bolts in each group as an example.

Particularly, Step 120 comprises the following steps:

Step 222, according to the serial number, applying a pre-tightening force on the i-th anchor bolt 8 in each group simultaneously until all the anchor bolts 8 in each group have been applied with a pre-tightening force equal to about half of a predetermined value, wherein, 1≦i≦N.

For example, the anchor bolts in the inner ring with serial numbers of “1”, “33”, “65” and in the outer ring with serial numbers of “1”, “33”, “65” are applied simultaneously with a pre-tightening force equal to about half of the predetermined value; then the anchor bolts in the inner and outer rings with serial numbers of “2”, “34”, “66” are applied simultaneously with a pre-tightening force equal to about half of the predetermined value; likewise, until the anchor bolts in the inner and outer rings with serial numbers of “32”, “64”, “96” are applied simultaneously with a pre-tightening force equal to about half of the predetermined value. The manner of simultaneously applying a pre-tightening force in each group can make the tower flange and shimming flange in close contact, eliminate partial gaps, improve fixing reliability of the tower and ensure the safety of the tower. Since the pre-tightening force cannot be applied on the anchor bolts with a torque spanner, by numbering the anchor bolts, the pre-tightening force can be applied according to the requirements so as to avoid skipping, missing, or repeating applying force to the anchor bolts and the like, and influencing installation quality of the tower. Furthermore, numbering the anchor bolts also facilitates the subsequent checking on the applied pre-tightening force on the bolts, when there are problems on the bolts, the crux of the problem can be found by reviewing the applying process according to the applying record.

Step 223, according to the serial number, applying a pre-tightening force on the i-th anchor bolt in each group simultaneously until all the anchor bolts in each group have been applied with a pre-tightening force of the predetermined value, wherein, 1≦i≦N.

The Step 223 has the same principles with Step 222, and unnecessary details are not given here.

The operations of applying a pre-tightening force on an anchor bolt are divided into two steps, firstly, the anchor bolts are applied with a pre-tightening force equal to about half of the predetermined value, then the anchor bolts are applied with a pre-tightening force of the predetermined value, and such manner of applying force is more reasonable, preventing anchor bolts from being distorted due to being subjected to too much pre-tightening force at a time.

As shown in FIG. 3c, optionally, the number of tensioners 6 equals to the product of the number of groups of the anchor bolts 8 in each of the rings and the number of rings, and tensioners 6 used in each of the rings is connected in series. The schematic diagram of the tensioners in series is as shown in FIG. 3c, anchor bolts 8 in an inner ring and an outer ring are divided by tower wall 10, and the relative position relationship of shimming flange 11 and tower flange 9 is as shown in FIG. 3c. Tensioners 6 are connected to an oil pump 13 via an oil pipe 12. In the embodiment of the present invention, anchor bolts 8 are divided into six groups, and the inner ring and the outer ring each has three groups, three tensioners 6 used in the inner ring are connected in series while three tensioners 6 used in the outer ring are connected in series. Since oil pipes of tensioners 6 have slight distortion when oil pressure in oil pipes rises, such distortion will reduce the rising speed of oil pressure and such influence becomes more significant as the pipeline becomes longer. Based on the process requirements that the anchor bolts 8 are divided into at least two groups for tensioning, in order to reduce the length of oil pipes as much as possible, the tensioners 6 are connected by means of two-path series connection, that is, several tensioners 6 for tensioning anchor bolts 8 in the outer ring are connected in series in one group, while several tensioners 6 for tensioning anchor bolts 8 in the inner ring are connected in series in another group, and two paths of oil pipes are connected to oil pump 13 via a distributor. In this way, except that one oil pipe entering the tower needs to be lengthened appropriately based on the height of tower door, the rest five oil pipes have a maximum length of approximately ⅓ of the tower perimeter. Oil pump can be disposed on the ground outside the tower door, for convenience of observation and signal liaison of the operators. Stretching bolts in this method needs seven workers, that is, six operators for tensioner and one operator for oil pump. In this way, the length of pipelines for connecting the tensioners is reduced, rising speed of pressure in oil pump is increased, working intensity of oil pump is reduced and working efficiency of tensioning anchor bolts is improved.

It should be noted that, after completion of the installation of wind turbine, the pre-tightening force of anchor bolts should be checked one by one in half a year, one year and two years, the checking sequence for the pre-tightening force should also be done according to the numbering sequence of the bolts. Thereafter, a sample of 10% of the bolts is randomly selected for checking the pre-tightening force every year to make sure the bolts have no loss in the pre-tightening force. All the checking work should have written records for review.

According to Embodiment 2 of the present invention, the method of applying a pre-tightening force on an anchor bolt divides the anchor bolts into groups and applies a pre-tightening force on certain anchor bolt in each group simultaneously, effectively ensuring that each anchor bolt has been applied with a pre-tightening force. Furthermore, the pre-tightening force can be applied two times, firstly applying a pre-tightening force equal to about half of a predetermined value, and then applying a pre-tightening force of the predetermined value, thus avoiding gaps between the tower flange and the shimming flange and ensuring installation reliability of the tower.

Finally, it should be noted that the above embodiments are merely provided for describing the technical solutions of the present invention, but not intended to limit the present invention. It should be understood by those skilled in the art that although the present invention has been described in detail with reference to the foregoing embodiments, modifications can be made to the technical solutions described in the foregoing embodiments, or equivalent replacements can be made to some technical features in the technical solutions, and such modifications or replacements do not cause the essence of corresponding technical solutions to depart from the spirit and scope of the embodiments of the present invention.

What is claimed is:

1. A method of applying a pre-tightening force on an anchor bolt, comprising:
installing a washer with a predetermined dimension between a tower flange and a fastening nut, wherein the washer is configured to support a supporting bridge of a tensioner;
applying a pre-tightening force on anchor bolts arranged in at least one inner ring and one outer ring installed on the tower flange with the tensioner.

2. The method of applying a pre-tightening force on an anchor bolt according to claim 1, wherein, before installing the washer with a predetermined dimension between the tower flange and the fastening nut for supporting a supporting bridge of the tensioner, further comprising:
numbering the anchor bolts in each of the rings, and recording a serial number of each anchor bolt, wherein the anchor bolts in each of the rings are equally divided into at least two groups, the number of the anchor bolts in each group is N, and N is a natural number.

3. The method of applying a pre-tightening force on an anchor bolt according to claim 2, wherein, the step of applying a pre-tightening force on the anchor bolts in the inner ring and the outer ring installed on the tower flange comprises:
according to the serial number, applying a pre-tightening force on the i-th anchor bolt in each group simultaneously until all the anchor bolts in each group have been applied with a pre-tightening force equal to half of a predetermined value, wherein, 1≦i≦N;
according to the serial number, applying a pre-tightening force on the i-th anchor bolt in each group simultaneously until all the anchor bolts in each group have been applied with a pre-tightening force of the predetermined value, wherein, 1≦i≦N.

4. The method of applying a pre-tightening force on an anchor bolt according to claim 2, wherein, the step of numbering the anchor bolts in each of the rings comprises:
numbering the anchor bolt positioned right facing a tower door of the tower in each of the rings as “1”, and numbering successively all the anchor bolts in each of the rings in the clockwise direction.

5. The method of applying a pre-tightening force on an anchor bolt according to claim 3, wherein:
the number of the tensioners equals to the product of the number of groups of the anchor bolts in each of the rings and the number of the rings, and the tensioners used in each of the rings are connected in series.

6. The method of applying a pre-tightening force on an anchor bolt according to claim 2, wherein, the recording the serial number of each anchor bolt comprises:
marking the serial number on the anchor bolt with pigment.

7. The method of applying a pre-tightening force on an anchor bolt according to claim 1, wherein:
a length of the anchor bolt clamped by a stretching head of the tensioner is no less than 1.5 times of the diameter of the anchor bolt.

8. The method of applying a pre-tightening force on an anchor bolt according to claim 1, wherein:
the predetermined dimension of the washer is the radial dimension of the washer, which is greater than the radial dimension of the supporting bridge of the tensioner.
